(19) United States
(12) Patent Application Publication
(10) Pub. No.: US 2024/0284140 A1
(43) Pub. Date: Aug. 22, 2024

(54) CORNERING CORRECTION FOR SPATIAL AUDIO HEAD TRACKING

(71) Applicant: Bose Corporation, Framingham, MA (US)

(72) Inventors: Thomas Landemaine, Allston, MA (US); Yang Liu, Sudbury, MA (US); Tobe Z. Barksdale, Bolton, MA (US)

(21) Appl. No.: 18/111,311

(22) Filed: Feb. 17, 2023

(51) Int. Cl. H04S 7/00

(52) U.S. Cl. CPC H04S 7/304; H04S 2400/01; H04S 2400/11

(57) ABSTRACT

A method is provided for adapting an anchor position for relative locations of one or more virtual loudspeakers. The method includes: detecting a cornering motion of a user, and adapting the anchor position based on the detected cornering motion such that the anchor position remains centered in front of the user through the cornering motion.

### BACKGROUND

The term ‘spatialized audio’ may refer to a variety of audio or acoustic experiences, and in some spatialized audio may refer to a simulated experience of one or more virtual, out loud (e.g., loudspeakers), typically delivered to a user or listener via headphones, earbuds, or other suitable wearable audio device. Such a virtualized speaker experience is intended to sound or be perceived by the user as originating at a location in the nearby environment of the user, not from the headphones themselves. For example, conventional stereo listening on headphones can sound as if the audio is coming from within the user's head, but a stereo spatialized audio experience may sound like there are left and right (virtual) loudspeakers in front of the user. There are numerous techniques for achieving such an experience, at least one of which is disclosed in U.S. patent application Ser. No. 16/592,454 filed Oct. 3, 2019, titled SYSTEMS AND METHODS FOR SOUND SOURCE VIRTUALIZATION, which is published as U.S. Patent Application Publication No. 2020/0037097. There exists a need for various adjustments to the perceived locations of virtual sound sources within spatialized audio systems, methods, and processing.

### SUMMARY

Systems and methods disclosed herein are directed to audio rendering systems, methods, and applications. In particular, systems and methods disclosed are directed to audio systems and methods that produce audio perceived by a user or listener to come from (or be generated at) a virtual location in the area of the user when there may be no real sound source at the virtual location. Various systems and methods herein may produce spatialized sound from multiple virtual locations, such as a virtualized multi-channel surround sound system.

Systems and methods herein establish a location, which may be centered in front of the user/listener in some cases, as an anchor position around which the various virtual sound source locations will be established. For example, the location from which a center channel of a multi-channel audio system is to be perceived as originating may be an anchor position, while virtual left and right speakers may be rendered by the audio systems and methods to be perceived as originating from locations to the left and right of the anchor position. Similarly, virtual rear speakers, virtual height channels, virtual object audio sources (e.g., the perceived location of their source moves around the listener, such as by tracking a virtual object), and/or other virtual source and/or reference locations used by various systems and methods may be suitable. In various examples, an anchor position may be any suitable position and may or may not be associated with a particular perceived virtual source location. In some examples, an anchor position may be defined relative to a user of the system or method.

In one aspect, a method is provided for adapting an anchor position for relative locations of one or more virtual loudspeakers. The method includes: detecting a cornering motion of a user; and adapting the anchor position based on the detected cornering motion such that the anchor position remains centered in front of the user through the cornering motion.

Implementations may include one of the following features, or any combination thereof.

In some implementations, detecting the cornering motion includes processing signals from a plurality of sensors to disambiguate a head spin from a cornering motion.

In certain implementations, processing the signals from the plurality of sensors includes: (i) processing the signals to provide a tangential acceleration, a centripetal acceleration, and an angular velocity; and (ii) disambiguating a head spin from a cornering motion based on the tangential acceleration, the centripetal acceleration, and the angular velocity.

In some cases, the method also includes: (i) smoothing the tangential acceleration, the centripetal acceleration, and the angular velocity to provide a smoothed tangential acceleration, a smoothed centripetal acceleration, and a smoothed angular velocity; and (ii) disambiguating a head spin from a cornering motion based on the smoothed tangential acceleration, the smoothed centripetal acceleration, and the smoothed angular velocity.

In certain cases, processing the signals from the plurality of sensors includes processing the signals to calculate an estimate of a rotation radius.

In some examples, if the rotation radius is small and points inside the user's head, then the method does not adapt the anchor position, and, if the rotation radius points outside the user's head, then the method adapts the anchor position.

In certain examples, the rotation radius is a vector that includes a magnitude and an angle and the magnitude, the angle, or a combination thereof is used to determine if the rotation radius points inside or outside the user's head.

In some implementations, processing the signals from the plurality of sensors includes processing signals corresponding to a linear acceleration and processing signals corresponding to an angular velocity.

In certain implementations, the plurality of sensors includes a gyroscope and an accelerometer.

In some cases, the cornering motion is attributable to a movement of the user's body relative ground when the user is walking or traveling on a moving platform.

In certain cases, the plurality of sensors is provided by a single inertial measurement unit (IMU).

In some examples, the plurality of sensors is provided by a plurality of IMUs.

In certain examples, adapting the anchor position comprises performing quaternion correction on a game rotation vector provided by the plurality of sensors.

In another aspect, an apparatus includes a first acoustic transducer, an inertial measurement unit (IMU), a processor configured to process signals from the IMU, and memory. The memory stores instructions, which, when executed by the processor, cause the processor to: detect a cornering motion of a user based on the signals received from the IMU; and adapt an anchor position for relative locations of one or more virtual loudspeakers based on the detected cornering motion such that the anchor position remains centered in front of the user through the cornering motion.

Implementations may include one of the above and/or below features, or any combination thereof.

In some implementations, the memory includes instructions, which, when executed by the processor, cause the processor to: detect the cornering motion by processing the signals from the IMU to disambiguate a head spin from a cornering motion.

In certain implementations, the memory includes instructions, which, when executed by the processor, cause the processor to: process the signals from the IMU to provide a tangential acceleration, a centripetal acceleration, and an angular velocity and disambiguating a head spin from a cornering motion based on the tangential acceleration, the centripetal acceleration, and the angular velocity.

In some cases, the memory includes instructions, which, when executed by the processor, cause the processor to: process the signals to calculate an estimate of a rotation radius and to disambiguate a head spin from a cornering motion based on the estimate of the rotation radius.

In certain cases, the memory includes instructions, which, when executed by the processor, cause the processor to: perform quaternion correction on a game rotation vector provided by the IMU.

In some examples, the IMU comprises a plurality of IMUs.

In certain examples the plurality of IMUs comprises a first IMU that is configured to sit on a first side of a user's head when the apparatus is used and a second IMU that is configured to sit on a second, opposite side of the user's head when the apparatus is used.

In some implementations, the apparatus includes a headphone. The headphone may include a first earpiece supporting the first acoustic transducer; and a second earpiece supporting a second acoustic transducer, and the IMU may include: a first IMU supported by the first earpiece; and a second IMU supported by the second earpiece.

In certain implementations, the first earpiece includes a first earcup, the second earpiece includes a second earcup, and the apparatus may also include a headband that couples the first earcup to the second earcup.

In some cases, the headband supports wiring that electrically couples the first IMU and the second IMU.

In certain cases, the first IMU and the second IMU are wirelessly connected to each other via a wireless data link.

In some examples, the first IMU and the second IMU are mounted in physically mirrored positions on the first and second earcups, respectively.

In certain examples, the first IMU and the second IMU are mounted such that they are not in physically mirrored positions and an axes remapping is applied to the first IMU and the second IMU such that the remapped axes are in virtual mirrored positions.

In some implementations, the memory includes instructions, which, when executed by the processor, cause the processor to: synchronize the first and second IMUs.

In certain implementations, the first IMU is at least a 6-axis IMU that is configured to provide periodic reports of linear acceleration and angular velocity to the processor, and the second IMU is at least a 3-axis IMU that is configured to provide periodic reports of linear acceleration that are synchronized to the reports of the first IMU.

In some cases, the first earpiece includes a first earbud and the second earpiece includes a second earbud.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a schematic view of an example listener scenario;

FIG. 2 is a schematic view of an example spatial audio scenario;

FIG. 3 is a schematic view of an example spatial audio centering scenario;

FIGS. 4A & 4B are front and side views, respectively, of a pair of headphones equipped with an inertial measurement unit (IMU);

FIG. 5 is an illustration of a point O orbiting around center point C with angular velocity Ω with tangential direction e_{θ,O} and centripetal direction e_{r,O};

FIG. 6 is a diagrammatic representation of signal processing for cornering compensation using radius estimation from 1 IMU;

FIG. 7 is a front view of a pair of headphones equipped with 2 IMUs;

FIG. 8 is an illustration of a rigid body rotating around its center O, with O rotating around a fixed center C;

FIG. 9 is a diagrammatic representation of signal processing for cornering compensation using the left and right earcup motion accelerations from 2 IMUs; and

FIG. 10 is a diagrammatic representation of signal processing for cornering compensation from turn radius estimation from 1 IMU.

### DETAILED DESCRIPTION

Aspects of the present disclosure are directed to apparatus, systems and methods that utilize measurements from one or more inertial measurement units (IMUs) to infer if and how much a user is making a body cornering motion and adjust a sound stage accordingly.

The term “headphone” as used herein is intended to mean any sound producing device that is configured to provide acoustic energy to each of a user's left and right ears, and to provide some isolation or control over what arrives at each ear without being heard at the opposing ear. Such devices often fit around, on, in, or proximate to a user's ears in order to radiate acoustic energy into the user's ear canal. Headphones may be referred to as earphones, earpieces, earbuds, or ear cups, and can be wired or wireless. Headphones may be integrated into another wearable device, such as a headset, helmet, hat, hood, smart glasses or clothing, etc. The term “headphone” as used herein is also intended to include other form factors capable of providing binaural acoustic energy, such as headrest speakers in an automobile or other vehicle. Further examples include neck-worn devices, eyewear, or other structures, such as may hook around the ear or otherwise configured to be positioned proximate a user's ears. Accordingly, various examples may include open-ear forms as well as over-ear or around-ear forms. A headphone may include an acoustic driver to transduce audio signals to acoustic energy. The acoustic driver may be housed in an ear cup or earbud, or may be open-ear, or may be associated with other structures as described, such as a headrest. A headphone may be a single stand-alone unit or one of a pair of headphones, such as one headphone for each ear.

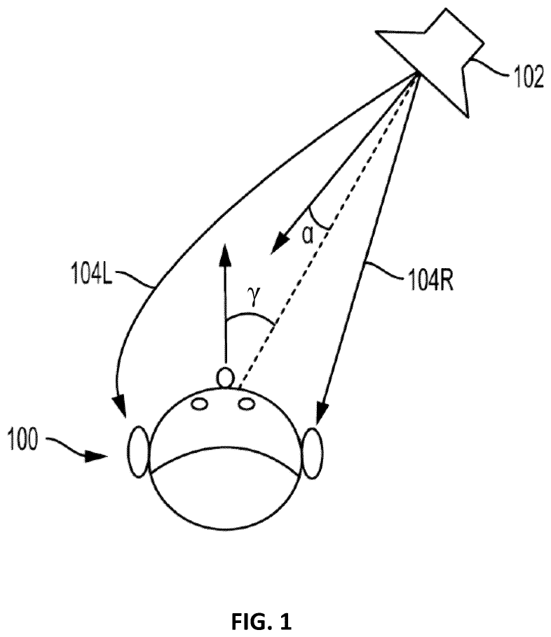

FIG. 1 schematically illustrates a user 100 receiving sound from a sound source 102. Head related transfer function (HRTFs) may be calculated or stored in a memory that characterize how the user 100 receives sound from various directions and are represented by arrows as a left HRTF 104L and a right HRTF 104R (collectively or generally HRTFs 104). The HRTFs 104 are at least partially defined based on an orientation of the user with respect to an arriving acoustic wave emanating from the sound source, indicated by an angle γ. That is, the angle γ represents the relation between the direction that the user 100 is facing with respect to the direction from which the sound arrives (represented by a dashed line). A directionality of the sound produced by the sound source 102 may be defined by a radiation pattern, which varies with the angle α, that represents the relation between the primary (or axial) direction in which the sound source 102 is producing sound and the direction to which the user 100 is located.

Spatialized audio, e.g., which processes audio signals to make sound be perceived as coming from the location of a virtual sound source (e.g., sound source 102) even if nothing is physically producing sound from said location, may be simulated in numerous ways. In some examples, one or more HRTFs 104 may be applied with the angle γ. In various examples, directionality of reflections off actual or virtual reflective surfaces (e.g., walls or other objects in a physical or virtual space) may be taken into account. In such examples, virtual reflected sounds will come from differing angles and with differing times of arrivals, each of which may be simulated by additional signal components representative of such reflections. In certain examples, the directionality of the virtual sound source (e.g., sound source 102), which is the radiation pattern of the sound source, may also be taken into account. As recited above, at least one example of a system to spatialize audio into one or more virtual sound sources may be found in in U.S. patent application Ser. No. 16/592,454 filed Oct. 3, 2019, titled SYSTEMS AND METHODS FOR SOUND SOURCE VIRTUALIZATION.

Regardless of various methods of processing audio signals to simulate virtual sound sources, the locations of virtual sound sources should remain relatively fixed, as if attached to an audio stage fixed in the world frame, as the head of the user 100 moves about. Accordingly, systems and methods herein may use various sensors and methods of detecting the orientation of the user's 100 head and may account for changes in HRTFs for direct and reflecting angles, and radiation patterns, as appropriate.

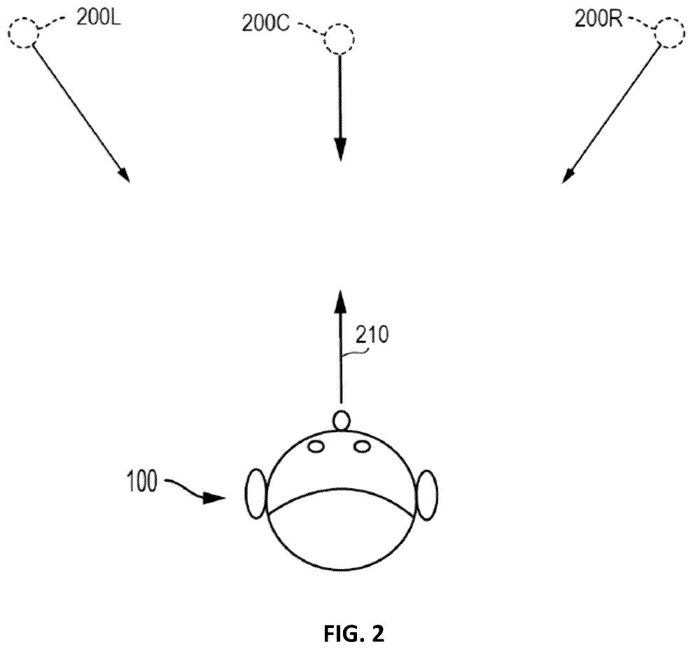

In various examples, however, it may be desirable to adjust the perceived location of virtual sound sources. For example, various apparatus, systems and methods in accord with those herein may position a virtual sound source directly in front of the user 100 to playback a center channel (or a phantom center channel, such as ‘center’ content not present in the audio source but derived from, e.g., a left-right stereo pair), and may position another virtual sound source to the left of front to playback a left-channel content and to position yet another virtual sound source to the right of front to playback a front-channel content, as illustrated in FIG. 2. Such an arrangement may function well while maintaining the positions of the virtual sound sources, which means adjusting for small movements in the user's head to account for changes in virtual audio directions, e.g., of direct, reflecting, and radiation patterns. However, if the user 100 decides to change position such that he is overall looking a different direction, it may be desirable to have the various positions of the virtual sound sources adjust to the user's new “normal” or front-facing position. For example, if a user is walking and makes a right turn, the front, left, and right channel contents will be perceived as remaining in place, and will now all be on one side of the user rather than in front of the user.

When a user is on the move, such as walking and running, it can be beneficial to align the sound stage (aka “audio stage”) so that the user does not feel the sound stage is off centered or collapsed into his/her head. In other words, it can be beneficial to correct for the sound stage when the user is making cornering motions. This leads to a desirable placement of the audio stage while preserving externalization. This experience may also be desirable when the user is on a moving platform such as cars or planes, in which case it can be beneficial to anchor the sound stage to the body of the moving platform. The challenge here is that it is not always possible or practical to add an IMU to the human body or the vehicle. To address this, one or more IMUs mounted on a headphone can be relied on to infer if and how much the user is making a body cornering so that the sound stage can be adjusted accordingly. Various apparatus, systems and methods herein make adjustments to the chosen positions of the virtual sound sources to account for the user 100 making a cornering motion, such as when walking around a corner, where there is linear as well as rotational movement of the user's body.

Accordingly, apparatus, systems and methods herein adjust the location of virtual sound sources in response to movements of a user's body, particularly in a cornering motion. Spatialized audio systems and methods virtualize arriving signals such that the user may perceive one or more sounds to come from a fixed location, and such signals must be adjusted as the user moves their head to maintain the perception. Such adjustments due to changing arriving angles (generally discussed above with respect to FIG. 1) are not the adjustments discussed here. Instead, in addition to those perceptual adjustments to maintain virtual sound source position(s), apparatus, systems and methods in accord with those herein also adjust the virtual sound source position(s) in response to detecting cornering motions of the user's body. According to various examples, one or more virtual sound source positions may be placed or selected (by the system or by user preference) relative to an anchor position, and as the user's body moves, e.g., in a cornering motion, the anchor position may adapt to move in accord with the movement of the user's body, such that if the user changes a direction in which he or she is moving (e.g., walking), the sound stage of virtual sound sources about him/her will adapt to the new orientation, e.g., a virtual center channel will adjust to remain in front of the user, and other virtual channels will adjust accordingly, in various examples.

Illustrated in FIG. 2 is a user 100 listening to spatialized audio having a virtual left speaker 200L, a virtual right speaker 200R, and a virtual center speaker 200C (collectively, virtual speakers 200). Head orientation of the user 100 may be detected using any number of systems, sensors, and methods, and may be determined or aided by an inertial measurement unit (IMU) in some examples. Accordingly, a look-direction 210 may be determined and the location of the virtual center speaker 200C may be positioned straight in front of the user 100.

As the user's 100 head moves, through normal small changes in orientation, the virtual signals are adjusted to maintain the perceived location of the virtual speakers 200, as discussed above. However, according to various examples, if the orientation of a user's 100 body changes, such as during a cornering motion, systems and methods herein may move the positions of the virtual speakers 200 such that they remain centered in front of the user 100. The apparatus, systems and methods herein may also disambiguate between head turns (head spin) and a cornering motion and may respond differently in response to detecting a cornering motion versus a head spin. For example, the systems and methods herein may move the positions of the virtual speakers for detected cornering motions, but not for head spin. The cornering motion is attributable to the movement of the user's body relative to ground such as when walking or when the user is traveling on a moving platform such as cars or planes.

In various examples, systems and methods may select an anchor position, to which the positions of the virtual speakers 200 may be relative. In some examples, the anchor position may coincide with the position of the virtual center speaker 200C, but such need not be the case in other examples. Various apparatus, systems and methods may spatialize additional virtual speaker channels (e.g., rear left, rear right, height channels, etc.) and/or may spatialize additional or other virtual sound sources, such as moving virtual sound sources (e.g., the sound of a motorcycle driving by on the left, or the sound of an airplane flying by overhead, etc.). According to various examples, the positions of each of these sound sources may be characterized relative to a single anchor position, which in systems and methods in accord with those herein, will adjust to a cornering motion of the user 100.

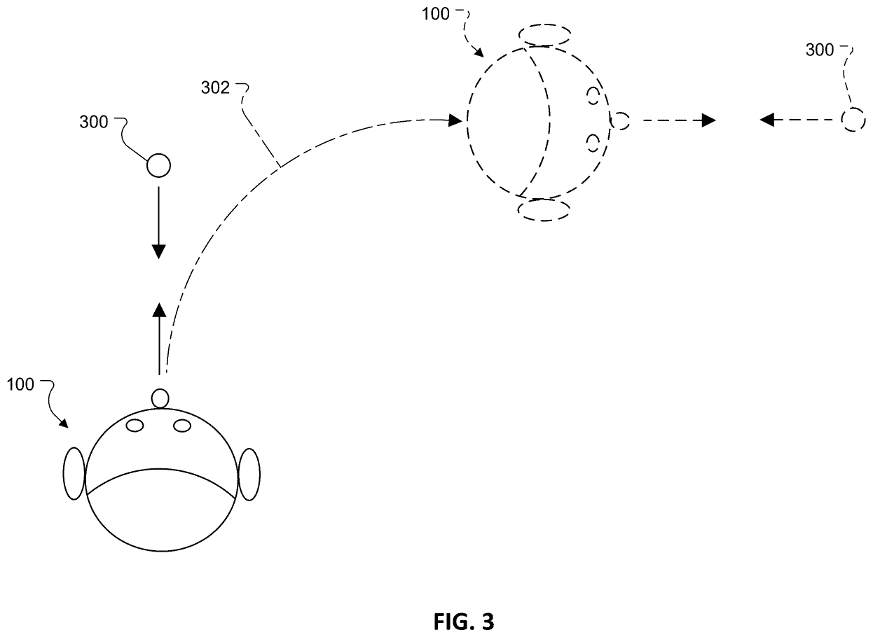

FIG. 3 illustrates an anchor position 300, which in this example is established directly in front of the user 100 and may in some cases align with the location of the virtual center speaker 200C (see FIG. 2), though not necessarily.

According to various examples, as the user's 100 body moves in a cornering motion (e.g., a change in orientation of the user's 100 body, such as when walking around a corner, as indicated by arrow 302) the anchor position 300 is adjusted so as to keep it centered in front of the user's body normal. Still, in other implementations, it may be desirable to adjust the anchor position so as to keep it centered in front of the user's head during cornering motions.

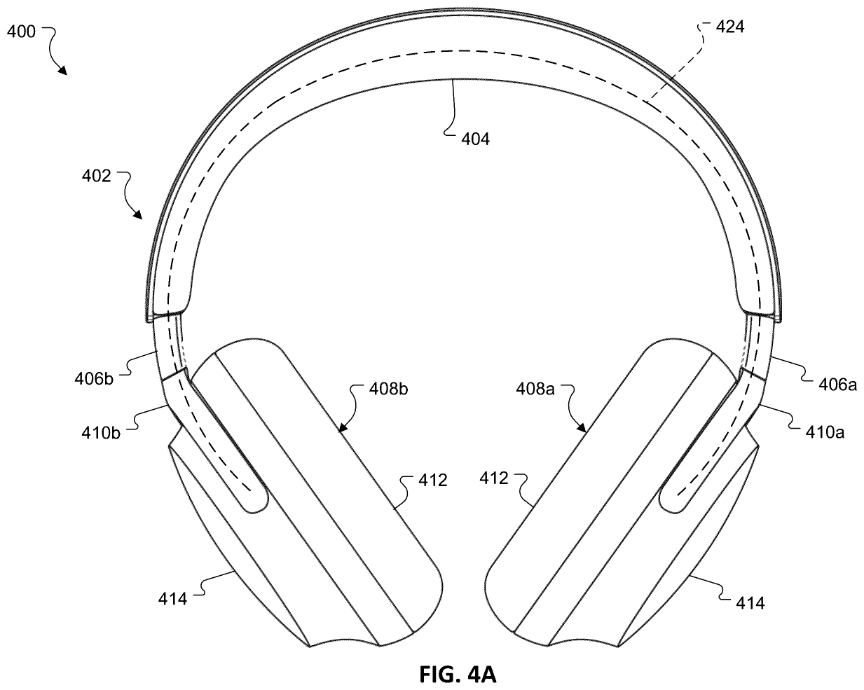

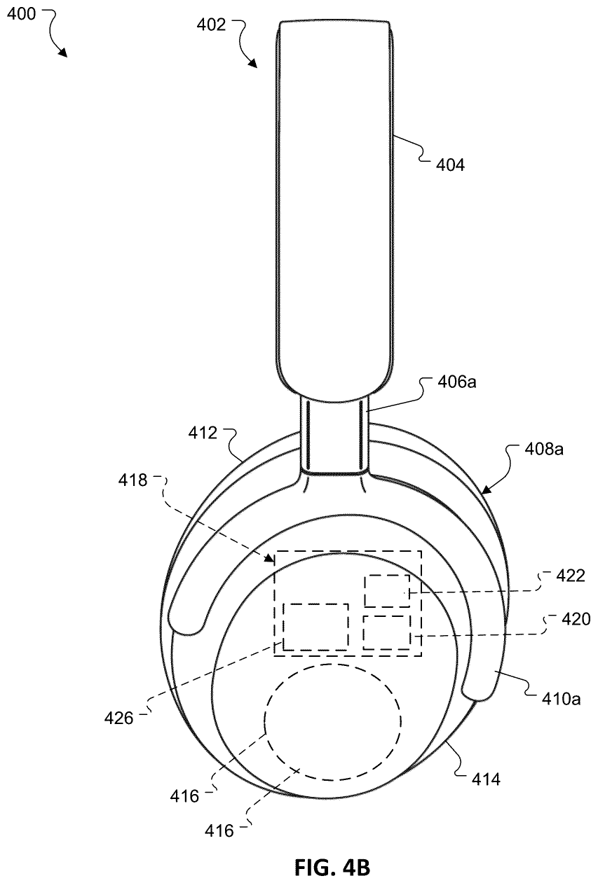

FIGS. 4A & 4B illustrate an exemplary pair of headphones 400 that may be used to implement the systems and methods described herein. Headphones 400 include headband 402 which includes flat tubular cushion assembly 404 that is constructed and arranged to be placed over the crown of the head of a person. Tubular sliders 406a and 406b (collectively “406”) support earphones 408a and 408b (collectively “408”). The sliders engage with cushion assembly 404 in a manner which allows the sliders to be moved in and out of the cushion assembly to adjust the overall length of the headband so that they headphones can sit comfortably on, in or over the ears of the wearer. This overall arrangement of headphones is known in the art. Also, in some cases a microphone (not shown) can be included so that the headphones can be used as a headset. Further, some headphones or headsets include only one earphone, in which case there may be only one slider.

Cushion assembly 404 is preferably generally tubular. This arrangement allows the sliders to be received within a volume on the inside of the tube and allows wiring to pass along the length of the cushion assembly. Sliders 406a and 406b are located, in part, in this interior volume of the cushion assembly. Coupling members 410a and 410b (collectively “410”) are pivotably coupled to sliders 406. The coupling members 410 each carry one of the earphones 408 (a/k/a “earpiece”) at their far ends. Each of the earphones 408 includes an ear cushion 412 and an earcup 414 that supports an electro-acoustic transducer 416 (FIG. 4B).

With reference to FIG. 4B, electronics 418 including a processor 420 and memory 422 may be housed in one or both of the earpieces 408. The memory 422 may be used to store instructions, which, when executed by the processor 420, carry out the methods described herein.

A conductive cable 424 (a/k/a “wiring,” FIG. 4A) interconnects earphones 408a and 408b and carries the audio signals that are played by the earphones. Cable 424 is flexible, and runs through coupling members 410, sliders 406, and cushion assembly 404. Cable 424 needs to have sufficient length to accommodate both sliders being slid out of the cushion assembly to their endpoints, and also allow the earphones to be moved from the deployed position to the stowed position. At the same time, cable 424 is managed so that it is unlikely to be bunched or pinched during use.

With reference to FIG. 4B, the headphones 400 include an inertial measurement unit (IMU) 426 that is supported by (e.g., mounted in or on) one of the earcups 414. An inertial measurement unit (IMU) is an electronic device that measures and reports a body's specific force, angular rate, and sometimes the orientation of the body, using a combination of accelerometers, gyroscopes, and sometimes magnetometers. For cornering detection, the angular velocity and linear acceleration input from the IMU 426 can be evaluated (via the processor 420) to detect when a user of the headphones 400 is making a cornering motion and the processor 420 can compensate for that by adjusting the acoustic output of headphones 400 to maintain sound stage in a position that is perceived as being centered in front of the user through the movement. As will be discussed below, the processor 420 can also use the input from the IMU 426 to disambiguate head spin (rotation of the user's head relative to his/her body) from a cornering motion.

Cornering Compensation Using Radius Estimation from 1 IMU

One approach for cornering motion compensation is to rely on a motion radius estimate from accelerometer and gyroscope data (provided by the IMU 426) to detect if body cornering motion is happening so that a game rotation vector can be modified accordingly to make sure the sound stage is anchored to the front of the body of the user.

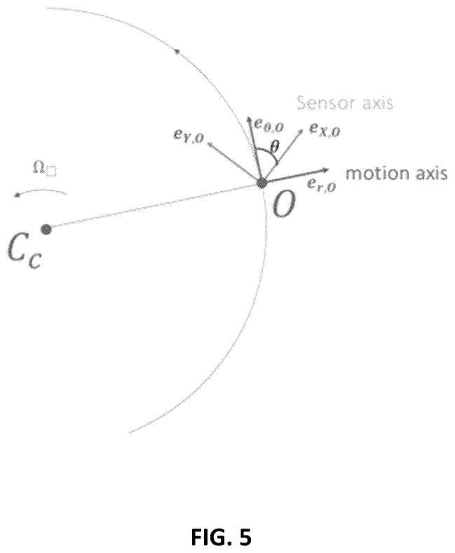

FIG. 5 illustrates an orbiting motion of a point O around a center C of an orbiting axis, where point O can self-rotate, causing a misalignment between its own rotating axis e_{X,O}/e_{Y,O} and the orbiting axis e_{θ,O}/e_{r,O}. More specifically, point O orbits around center point C with angular velocity Ω with tangential direction e_{θ,O} and centripetal direction e_{r,O}. The sensor axes are misaligned with the tangential and centripetal axis due to self-rotation and resulting an angle θ. When applied to a user wearing the headphones of FIG. 4A, where point O represents a fixed point on the IMU, this misalignment can happen whenever the body of the user is making a turn and the user's head is not aligned with his/her body due to head spinning. An objective of this cornering compensation approach is to estimate the motion tangential and centripetal accelerations from the sensor linear accelerations so the radius of the rotation/turning motion can be estimated. The detection of body cornering (aka “cornering motion”) can then be based off the observation that a cornering radius is usually detectably larger than a head spin radius (half the size of the head).

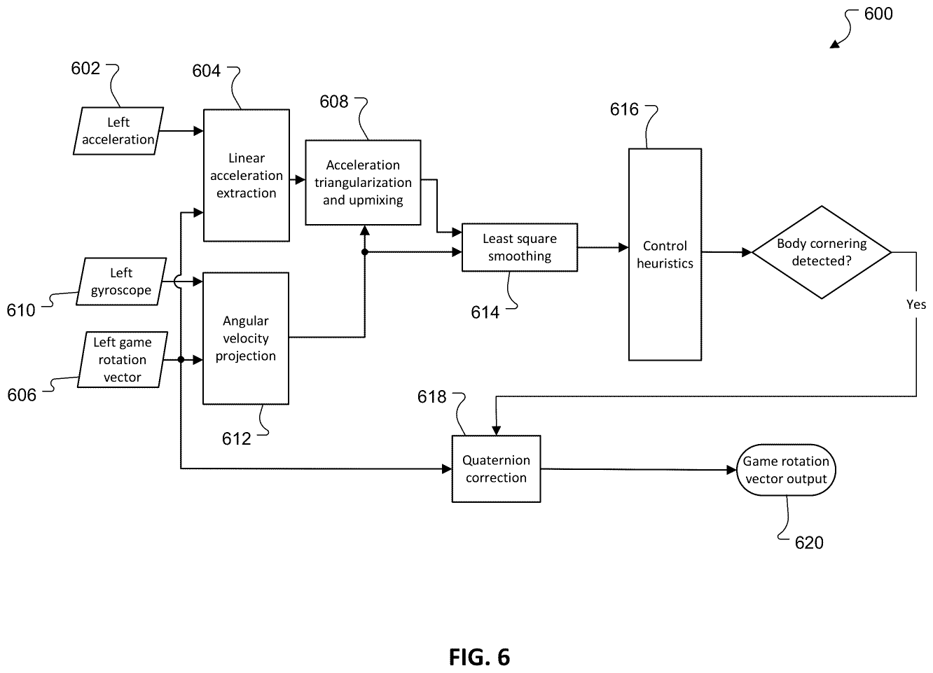

FIG. 6 illustrates the signal processing 600 for head spin and body cornering detections and quaternion game rotation vector correction. The IMU acceleration data 602 first go through linear acceleration extraction 604 which uses the game rotation vector data 606 from the IMU to remove the gravitational contributions to each of the accelerometer sensor axis. The x-axis and y-axis linear accelerations are then triangularized and upmixed 608 to estimate the motion tangential and centripetal accelerations.

The angular velocity data 610 from the IMU is projected 612 to the earth reference frame to extract the angular velocity around the earth upward axis. To reduce the error caused by the accelerometer noise, the motion accelerations go through a least squared smoothing process 614 against the angular velocity to estimate the rotation radius.

In that regard, the estimate of the rotation radius vector can be calculated according to the following equation (1):

$$= [ \begin{matrix} \\ \end{matrix} ] = \frac{E \{ [ \begin{matrix}{Ω}^{2} & - \dot{Ω} \\ \dot{Ω} & {Ω}^{2}\end{matrix} ] \vec{{a}_{L}} \}}{E \{ ( {Ω}^{4} + {\dot{Ω}}^{2} ) \}} \qquad ( 1 )$$

### Where:

[symbol] : estimated rotation radius vector, referenced to the sensor location
Ω: Z-component (where Z-axis points opposite to gravity) of the angular velocity,
\dot{Ω}: derivative of Ω: Z-component of the angular acceleration,
[symbol] : components of the linear acceleration of a point L, fixed to the IMU, in the XY plane orthogonal to the sensor Z-axis, and along the accelerometer axes, and
E{ }: the expectation operator, implemented for example using a low pass filter or exponential averaging.

Thresholding-based heuristics 616 are applied to the estimated rotation radius to determine when body cornering occurs (e.g., when the cornering radius is larger than the head radius), which then drives the quaternion correction 618 for the game rotation vector input 606 to decide where to steer the sound stage through the game rotation output 620.

Cornering Compensation Using Left and Right Motion Accelerations from 2 IMUs

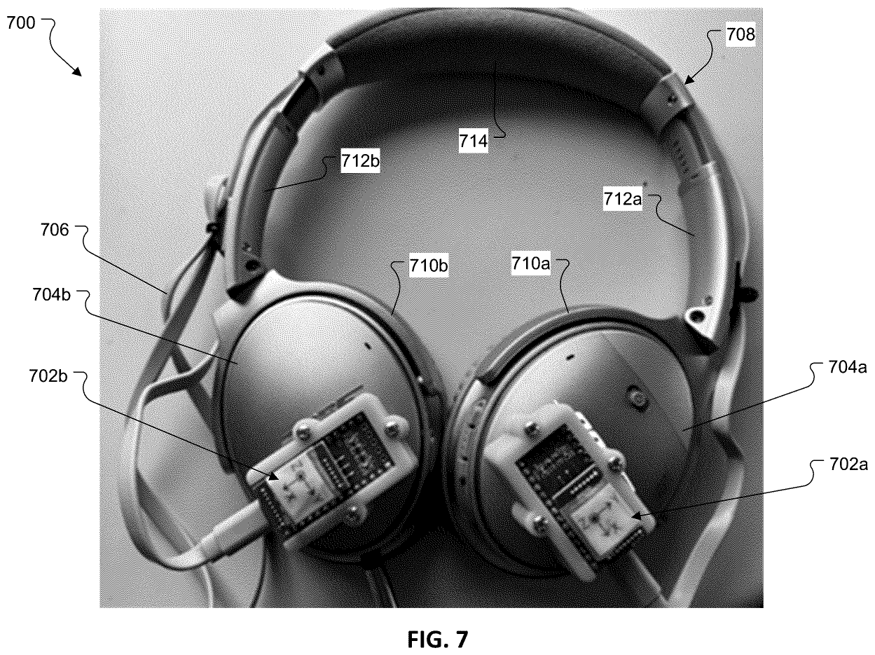

In some implementations, it may be beneficial to use the input from two IMUs for detecting cornering motion and disambiguating head spin. FIG. 7 illustrates an exemplary pair of headphones 700 that includes 2 IMUs 702a and 702b (collectively “702”) mounted on respective earcups 704a and 704b (collectively “704”). The IMUs 702 are connected to each other via cabling 706 that runs along the headband 708. While the illustrated example shows the IMUs 702 and the cabling 706 mounted external to the headphones 700, in some cases, the IMUs 702 may be mounted inside of the respective earcups 704 and the cabling 706 may be run through coupling members 710a and 710b, sliders 712a and 712b, and cushion assembly 714 such that it is hidden and protected. Connecting the IMUs using wires can be efficient for power consumption, synchronization and time alignment of signals, and data throughput purposes. However, in some cases, the IMUs can be connected wirelessly via a sufficiently capable data link (e.g., low latency Bluetooth).

The IMUs 702 are in electrical communication with electronics (not shown) that may be mounted internally to one or both of the earcups 704. The electronics include, among other things, a processor and memory, which may be embodied in a microprocessor. The processor executes instructions stored on the memory, which, when executed, carry out one or more of the methods described herein. A first one of the IMUs (e.g., the left-side IMU 702a) includes at least a 6-axis accelerometer and gyroscope a second one of the IMUs (e.g., the right-side IMU 702b) includes at least a 3-axis accelerometer. In some cases, both IMUs each include at least a 6-axis accelerometer and gyroscope.

For cornering detection, the accelerometer inputs from the IMUs 702 are observed on both earcups 704, e.g., via the processor, to exploit differential linear acceleration between the sides of the head, to help disambiguate head spin from cornering motion. The angular velocity from the gyroscope on one side of the headphones 700 is observed to lower cornering detection false triggers while walking and running in a straight line. The head spin and body cornering detection and their disambiguation rely on the symmetry/anti-symmetry of the tangential and centripetal linear accelerations of the left-side and right-side of the headphones 700 for different motions. This requires the left-side IMU 702a and right-side IMU 702b to be synchronized and mounted in mirrored positions. In that regard, the IMUs may be physically mounted in mirrored positions, or the IMUs may be mounted such that they are not in physically mirrored positions and an axes remapping may be applied to each IMU so that the remapped axes are in mirrored positions (i.e., virtual mirrored positions).

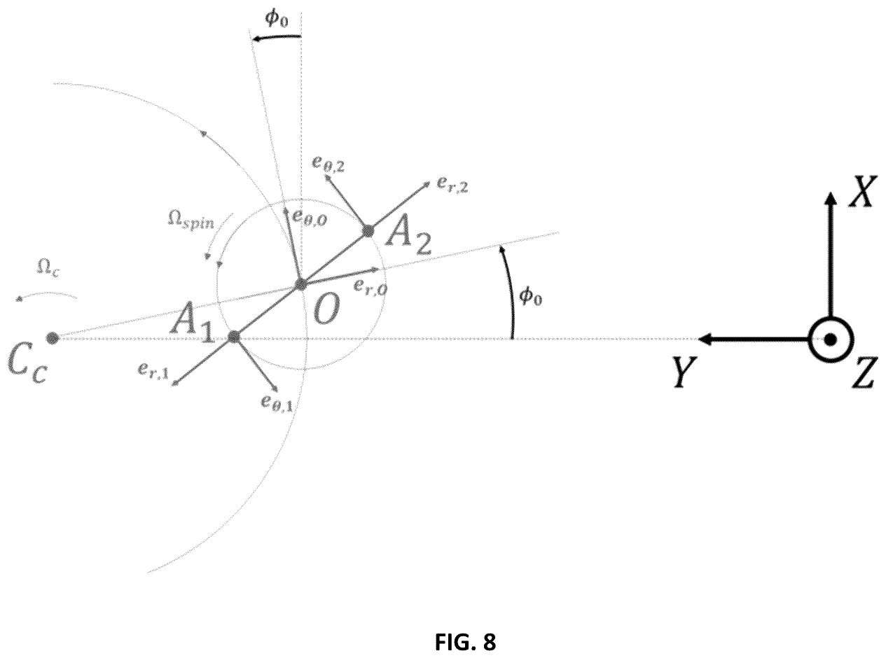

The main idea of the 2-IMU head spin and body cornering detection and disambiguation approach relies on the rigid body motion physics illustrated in FIG. 8 such that:
1) For head spin, the tangential accelerations, a_{θ}_{₁} and a_{θ}_{₂}, on both sides of the head have opposite directions (e_{θ}_{₁}=−e_{θ}_{₂}) and same magnitudes; The centripetal accelerations, aᵣ_{₁} and aᵣ_{₂}, on both sides of the head have opposite directions (eᵣ_{₁}=−eᵣ_{₂}) towards the inside of the head and same magnitudes; and
2) For body cornering, the tangential accelerations on both sides of the head have the same directions and same magnitudes; The centripetal acceleration on both sides of the head have the same directions and almost the same magnitudes.

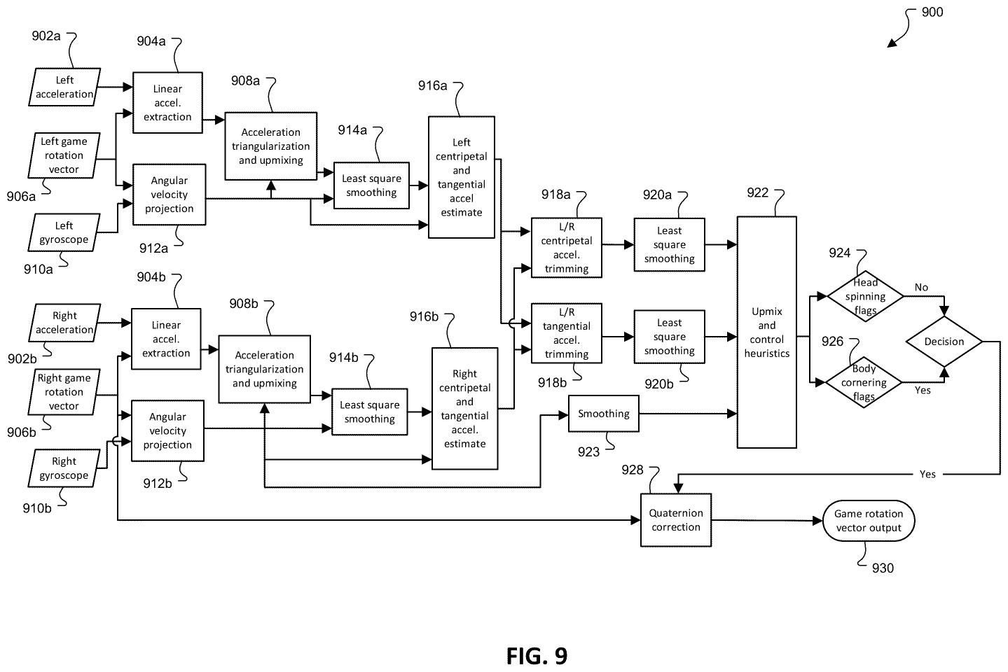

FIG. 9 is a diagram that describes the signal processing 900 for head spin and body cornering detections and the quaternion game rotation correction using the 2-IMU system of FIG. 7. The rotation radius estimates for both the left and the right side follow the same process as in the 1-IMU algorithm in FIG. 6. The IMU acceleration data 902a and 902b (collectively “902”) first go through linear acceleration extraction 904a and 904b which uses the game rotation vector data 906a and 906b from respective ones of the IMUs to remove the gravitational contributions to each of the accelerometer sensor axis. The x-axis and y-axis linear accelerations are then triangularized and upmixed 908a and 908b to estimate the motion tangential and centripetal accelerations for both IMUs.

The angular velocity data 910a and 910b from the respective IMUs is projected 912a and 912b to the earth reference frame to extract the angular velocity around the earth upward axis. To reduce the error caused by the accelerometer noise, the motion accelerations go through a least squared smoothing process 914a and 914b against the angular velocity to estimate the rotation radius.

Having the rotation radius estimates, motion tangential and centripetal accelerations can be estimated 916a and 916b for both sides. The tangential and centripetal accelerations from both sides are then magnitude trimmed 918a and 918b and smoothed 920a and 920b before going through an upmixing stage 922 to construct the sum and difference between two sides of the head. The angular velocity data 910 from one side of the ear cup (e.g., the right side 910b) is projected 912 to the earth reference frame to extract the angular velocity around the earth upward axis and the projected angular velocity is smoothed 923. The smoothed centripetal, tangential accelerations and projected angular velocity go through control heuristics 922 to determine if head spin or body cornering occurs. Both head spin and body cornering flags 924, 926 drive the quaternion correction 928 for the game rotation vector input 906b (e.g., from the right side) to decide where to steer the audio stage through the game rotation vector output 930.

Cornering Compensation from Turn Radius Estimation from 1 IMU

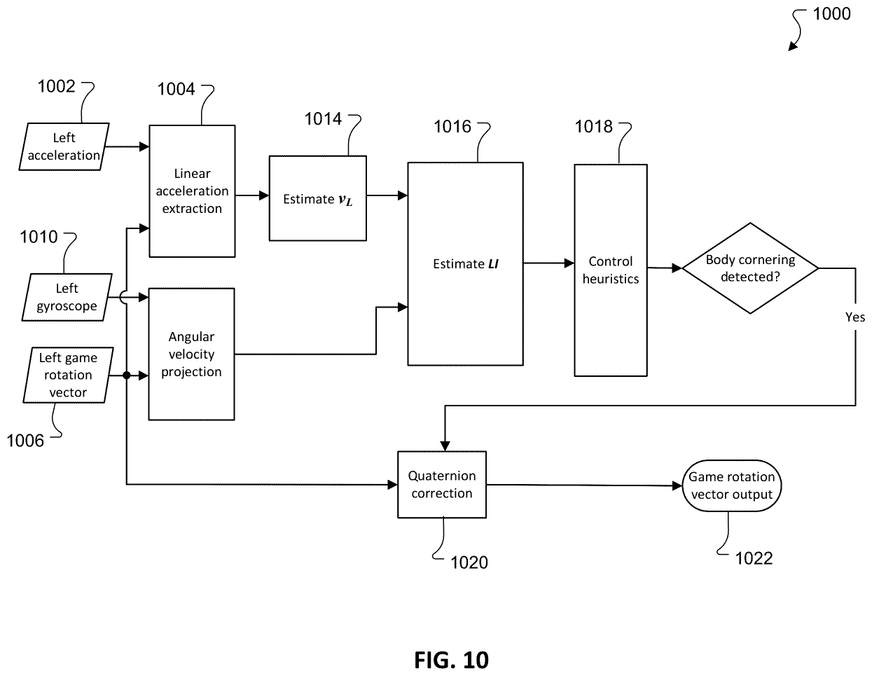

FIG. 10 illustrates the signal processing 1000 for yet another approach for cornering compensation that relies on being able to estimate the velocity of an IMU attached to a user's head, such as with the single-IMU system shown in FIGS. 4A &4B, and on the assumption that for realistic motions the instantaneous axis of rotation is relevant for the motion of the moving platform that is being compensated for.

The IMU acceleration data 1002 first go through linear acceleration extraction 1004 which uses the game rotation vector data 1006 from the IMU to remove the gravitational contributions to each of the accelerometer sensor axis.

The angular velocity data 1010 from the IMU is projected 1012 to the earth reference frame to extract the angular velocity around the earth upward axis. Then the projected angular velocity and the extracted linear acceleration can be used to calculate an estimate of the rotation radius according to the following formula:

$$LI = \frac{Ω \times {v}_{L}}{{\vert Ω \vert}^{2}} \qquad ( 2 )$$

Where,
LI is the estimate of the rotation radius,
L is a fixed point on the IMU,
ν_{L} is the linear velocity of point L, and
Ω is the angular velocity vector.

Estimating the velocity ν_{L} is more problematic since only the acceleration is measured and integrating the linear acceleration to get linear velocity from the accelerometer leads to drift over time of the velocity estimate V_{L}. The method attempts to calculate short-term estimates for the velocity ν_{L} by integrating the linear acceleration from the accelerometer signal and resetting the integration “under certain conditions”, with suitable initialization of the velocity V_{L}.

For example, a reset condition for acceleration integration to get ν_{L} is: detection of the start of a turn. An example of a “suitable” initialization of ν_{L} is: maintaining a moving average of the accelerometer signal, to get the starting velocity when we trigger integration of the accelerometer signal. In another example, ν_{L} may be reset to 0 when steps are detected.

Once ν_{L} is estimated 1014, it and the angular velocity vector Ω from the gyroscope (measured) are plugged into the formula (2) to estimate LI 1016.

To decide whether to correct for the moving platform, LI is evaluated 1018 by applying thresholding-based heuristics:
1.) If LI is small and points inside the head: the head is most likely moving, and so the system does not compensate for the rotation; and
2.) If LI points too far outside the head: the platform is most likely moving, so the system compensates for the rotation

The result of the evaluation of LI drives quaternion correction 1020 for the game rotation vector input 1006 to decide where to steer the audio stage through the quaternion output 1022.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

For example, while the foregoing methods have been described for use with banded headphones, in other implementations the methods described above may be executed by one or more earbuds (in-hear headphones) or by audio eyeglasses with one or more integrated IMUs.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method for adapting an anchor position for relative locations of one or more virtual loudspeakers, the method comprising:
detecting a cornering motion of a user; and
adapting the anchor position based on the detected cornering motion such that the anchor position remains centered in front of the user through the cornering motion.

2. The method of claim 1, wherein detecting the cornering motion comprises processing signals from a plurality of sensors to disambiguate a head spin from a cornering motion.

3. The method of claim 2, wherein processing the signals from the plurality of sensors comprises processing the signals to provide a tangential acceleration, a centripetal acceleration, and an angular velocity and disambiguating a head spin from a cornering motion based on the tangential acceleration, the centripetal acceleration, and the angular velocity.

4. The method of claim 3, further comprising smoothing the tangential acceleration, the centripetal acceleration, and the angular velocity to provide a smoothed tangential acceleration, a smoothed centripetal acceleration, and a smoothed angular velocity and disambiguating a head spin from a cornering motion based on the smoothed tangential acceleration, the smoothed centripetal acceleration, and the smoothed angular velocity.

5. The method of claim 2, wherein processing the signals from the plurality of sensors comprises processing the signals to calculate an estimate of a rotation radius.

6. The method of claim 5, wherein, if the rotation radius is small and points inside the user's head, then the method does not adapt the anchor position, and, if the rotation radius points outside the user's head, then the method adapts the anchor position.

7. The method of claim 6, wherein the rotation radius is a vector comprising a magnitude and an angle, and wherein the magnitude, the angle, or a combination thereof is used to determine if the rotation radius points inside or outside the user's head.

8. The method of claim 2, wherein processing the signals from the plurality of sensors comprises processing signals corresponding to a linear acceleration and processing signals corresponding to an angular velocity.

9. The method of claim 2, wherein the plurality of sensors comprises a gyroscope and an accelerometer.

10. The method of claim 2, wherein the cornering motion is attributable to a movement of the user's body relative ground when the user is walking or traveling on a moving platform.

11. The method of claim 2, wherein the plurality of sensors is provided by a single inertial measurement unit (IMU).

12. The method of claim 2, wherein the plurality of sensors is provided by a plurality of IMUs.

13. The method of claim 2, wherein adapting the anchor position comprises performing quaternion correction on a game rotation vector provided by the plurality of sensors.

14. An apparatus comprising:
a first acoustic transducer;
an inertial measurement unit (IMU);
a processor configured to process signals from the IMU; and
memory storing instructions, which, when executed by the processor, cause the processor to:
detect a cornering motion of a user based on the signals received from the IMU; and
adapt an anchor position for relative locations of one or more virtual loudspeakers based on the detected cornering motion such that the anchor position remains centered in front of the user through the cornering motion.

15. The apparatus of claim 14, wherein the memory includes instructions, which, when executed by the processor, cause the processor to: detect the cornering motion by processing the signals from the IMU to disambiguate a head spin from a cornering motion.

16. The apparatus of claim 15, wherein the memory includes instructions, which, when executed by the processor, cause the processor to: process the signals from the IMU to provide a tangential acceleration, a centripetal acceleration, and an angular velocity and disambiguating a head spin from a cornering motion based on the tangential acceleration, the centripetal acceleration, and the angular velocity.

17. The apparatus of claim 15, wherein the memory includes instructions, which, when executed by the processor, cause the processor to: process the signals to calculate an estimate of a rotation radius and to disambiguate a head spin from a cornering motion based on the estimate of the rotation radius.

18. The apparatus of claim 15, wherein the memory includes instructions, which, when executed by the processor, cause the processor to: perform quaternion correction on a game rotation vector provided by the IMU.

19. The apparatus of claim 14, wherein the IMU comprises a plurality of IMUs.

20. The apparatus of claim 19, wherein the plurality of IMUs comprises a first IMU configured to sit on a first side of a user's head when the apparatus is used and a second IMU configured to sit on a second, opposite side of the user's head when the apparatus is used.

21. The apparatus of claim 14, wherein the apparatus comprises a headphone, the headphone comprising:
a first earpiece supporting the first acoustic transducer; and
a second earpiece supporting a second acoustic transducer, and wherein the IMU comprises:
a first IMU supported by the first earpiece; and
a second IMU supported by the second earpiece.

22. The apparatus of claim 21, wherein the first earpiece comprises a first earcup, the second earpiece comprises a second earcup, and the apparatus further comprises a headband coupling the first earcup to the second earcup.

23. The apparatus of claim 22, wherein the headband supports wiring that electrically couples the first IMU and the second IMU.

24. The apparatus of claim 21, wherein the first IMU and the second IMU are wirelessly connected to each other via a wireless data link.

25. The apparatus of claim 21, wherein the first IMU and the second IMU are mounted in physically mirrored positions on the first and second earcups, respectively.

26. The apparatus of claim 21, wherein the first IMU and the second IMU are mounted such that they are not in physically mirrored positions and an axes remapping is applied to the first IMU and the second IMU such that the remapped axes are in virtual mirrored positions.

27. The apparatus of claim 21, wherein the memory includes instructions, which, when executed by the processor, cause the processor to: synchronize the first and second IMUs.

28. The apparatus of claim 21, wherein the first IMU is at least a 6-axis IMU that is configured to provide periodic reports of linear acceleration and angular velocity to the processor, and
wherein the second IMU is at least a 3-axis IMU that is configured to provide periodic reports of linear acceleration that are synchronized to the reports of the first IMU.

29. The apparatus of claim 21, wherein the first earpiece comprises a first earbud and the second earpiece comprises a second earbud.
